(19) United States
(12) Patent Application Publication
(10) Pub. No.: US 2026/0270902 A1
(43) Pub. Date: Sep. 10, 2026

(54) USER EQUIPMENT ACCESS RANDOMIZATION FOR TIMING RESILIENCY

(71) Applicant: APPLE INC., Cupertino, CA (US)

(72) Inventors: Ralf Rossbach, Munich (DE); Fangli Xu, Beijing (CN); Yuqin Chen, Beijing (CN); Naveen Kumar R Palle Venkata, San Diego, CA (US); Mona Agnel, Guildford (GB); Alexander Sirotkin, Hod Hasharon (IL); Ping-Heng Kuo, London (GB); Haijing Hu, Los Gatos, CA (US); Peng Cheng, Beijing (CN); Zhibin Wu, Los Altos, CA (US); Vivek G Gupta, San Jose, CA (US)

(21) Appl. No.: 19/166,670

(22) PCT Filed: Apr. 24, 2023
(86) PCT No.: PCT/CN2023/090279

§ 371 Date: Sep. 18, 2025

(51) Int. Cl. H04W 56/00; H04W 60/00

(52) U.S. Cl. CPC H04W 56/0015; H04W 60/00

(57) ABSTRACT

Systems and methods for user equipment (UE) timing resiliency are disclosed herein. When a timing source at the network degrades, this may be communicated to one or more UEs. The UEs may then perform random access channel (RACH) access procedures in an attempt to connect to the network and receive updated clock quality information. Embodiments herein relate mechanisms for randomizing/spreading such UE access attempts in time, such that system congestion is reduced. Embodiments of access stratum (AS)-timer-based UE access randomization, embodiments of non-access stratum (NAS)-timer-based UE access randomization, of embodiments of random access prioritization, and embodiments of unified access control (UAC) extensions for clock quality information retrieval are described herein. Also described are embodiments for performing a time synchronization update between the UE and the network while the UE remains in a non-connected state with respect to the network.

### TECHNICAL FIELD

This application relates generally to wireless communication systems, including wireless communication systems designed for enhanced timing resiliency.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB). Another example of an NG-RAN base station is a next generation eNB (ng-eNB).

A RAN provides its communication services with external entities through its connection to a core network (CN). For example, E-UTRAN may utilize an Evolved Packet Core (EPC) while NG-RAN may utilize a 5G Core Network (5GC).

### SUMMARY

According to an aspect, the present disclosure provides a method of a user equipment (UE), comprising: receiving, from a network, an indication that updated clock quality information is available; selecting a random time value between zero and a maximum clock quality information retrieval wait time; starting a timer for the random time value; and triggering a connection to the network upon expiration of the timer in order to enable reception, from the network, of the updated clock quality information.

According to another aspect, the present disclosure provides an apparatus comprising means to perform the method of a user equipment (UE) as described above.

According to another aspect, the present disclosure provides an apparatus of a user equipment (UE), comprising: one or more processors; and a memory storing instructions that, when executed by the one or more processors, configure the UE to: receive, from a network, an indication that updated clock quality information is available; select a random time value between zero and a maximum clock quality information retrieval wait time; start a timer for the random time value; and trigger a connection to the network upon expiration of the timer in order to enable reception, from the network, of the updated clock quality information.

According to another aspect, the present disclosure provides a non-transitory computer-readable storage medium including instructions that when executed by one or more processors of a user equipment (UE), cause the UE to: receive, from a network, an indication that updated clock quality information is available; select a random time value between zero and a maximum clock quality information retrieval wait time; start a timer for the random time value; and trigger a connection to the network upon expiration of the timer in order to enable reception, from the network, of the updated clock quality information.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a 5G timing resiliency system, according to embodiments discussed herein.

FIG. 2 illustrates objectives for NR timing resiliency and URLLC enhancements in as may be understood in some wireless communications systems.

FIG. 3 illustrates a 5GS, according to embodiments discussed herein.

FIG. 4 illustrates an RA-prioritization IE that accounts for the use of an access identity for UE access for clock quality information retrieval, according to embodiments herein.

FIG. 5 illustrates a portion of a procedure for initialization of variables specific to an RA type that accounts for the use of a new access identity used for UE access for clock quality information retrieval, according to embodiments discussed herein.

FIG. 6A illustrates a new field that may be inserted in a RACH-ConfigCommon IE, and that may be applicable to the use of the new access identity used for UE access for clock quality information retrieval within some wireless communication systems.

FIG. 6B illustrates a new field that may be inserted in a RACH-ConfigCommonTwoStepRA-r16 IE, and that may be applicable to the use of the new access identity used for UE access for clock quality information retrieval within some wireless communication systems.

FIG. 7A illustrates definitions for a UAC-BarringInfoSetList IE and a UAC-BarringInfoSet IE that may be used in various wireless communications systems.

FIG. 7B illustrates definitions for a UAC-BarringPerCatList IE and a UAC-BarringPerCat IE that may be used in various wireless communication systems.

FIG. 7C illustrates definitions for a UAC-BarringPerPMLNList IE and a UAC-BarringPerPLMN IE that may be used in various wireless communication systems.

FIG. 8 illustrates a table for an access identity associated with access attempts related to clock quality information retrieval, according to embodiments discussed herein.

FIG. 9 illustrates a procedure of a UE for using an access identity associated with access attempts related to clock quality information retrieval, according to embodiments disclosed herein.

FIG. 10 illustrates a SIB1-v1800-IE listing having extended barring information for UAC contexts, as may be broadcast in wireless communication systems implementing embodiments discussed herein.

FIG. 11A illustrates a definition for a uac-BarringInfoSetList-v1800 IE, as may be used in wireless communication systems implementing embodiments discussed herein.

FIG. 11B illustrates descriptions for each of a barring factor and a barring time as may be used within a uac-BarringInfoSetList-v1800 IE.

FIG. 12 illustrates a table for an access identity associated with access attempts related to clock quality information retrieval in an NAS context, according to embodiments discussed herein.

FIG. 13A and FIG. 13B together illustrate a table for an access identity associated with access attempts related to clock quality information retrieval in an NAS context, according to embodiments discussed herein.

FIG. 14 illustrates an option for a rule for a mapping table used to determine access categories in a NAS context, as may be used in wireless communication systems discussed herein.

FIG. 15 illustrates a method of a UE, according to embodiments herein.

FIG. 16 illustrates a method of a RAN, according to embodiments herein.

FIG. 17 illustrates an example architecture of a wireless communication system, according to embodiments disclosed herein.

FIG. 18 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

For example, a 5G system (5GS) may use a local GNSS server, and/or may be time synchronized with an external clock using transport network synchronization protocols, etc. In some 5GSs, a 5G Grand Master (GM) clock and/or a synchronization plane of the 5G network (for RAN and CN) may have different time/frequency sources (such as a GNSS signal, Synchronous Ethernet (Sync E), PTP transport network, PPS input, etc.).

In some wireless communication systems, timing resiliency and/or ultra-reliable low latency communications (URLLC) enhancements may include enabling the system (e.g., a 5G system (5GS)) to use a backup for/alternative mechanism from a current time distribution source.

For example, there may be requirement(s) for a 5GS to remain time resilient after a GNSS failure and to act as a backup and offer wireless and/or indoor-capable time synchronization service for other applications (e.g. financial applications, power grid systems applications, factory use-case applications, etc.).

For example, see 3GPP Technical Specification (TS) 22.261, version 19.2.0, clause 6.36 (March 2023), where work was preceded by a study in 3GPP Technical Report (TR) 22.878, version 18.2.0 (December 2021). Note also that another completed study on “5G Timing Resiliency and TSC & URLLC enhancements” (FS_5TRS_URLLC) is captured in 3GPP TR 23.700-25, version 18.1.0 (March 2023), which discusses a key issue (KI) with relevance to disclosure herein as KI #1: 5GS network timing synchronization status and reporting.

Note that while many examples for a backup/alternative mechanism given discussed herein are provided in the context of a failure of GNSS-based time distribution source, it will nevertheless be understood that such methodologies could be analogously provided in cases of a failure of another type of time distribution source (other than GNSS) that is currently being used.

Further, it may be beneficial to support/meet various timing resiliency requirements, such as a reporting of a network timing synchronization status (such as divergence from universal time coordinated (UTC) and/or network timing source degradation) to UEs and/or 3rd party application functions (AFs), to support the ability for a RAN and/or a core network (e.g., a 5GC) to determine/learn about a network timing synchronization status and to be able to inform UEs and AFs regarding the network timing synchronization status, and/or to support the provision of a timing synchronization status to UEs and AFs.

For example, see a work item on Timing Resiliency and URLLC Enhancements (TRS_URLLC), 3GPP Technical Specification Group (TSG) Services and System Aspects (SA) Meeting #SP-99, SP-230107 (Mar. 21-24, 2023).

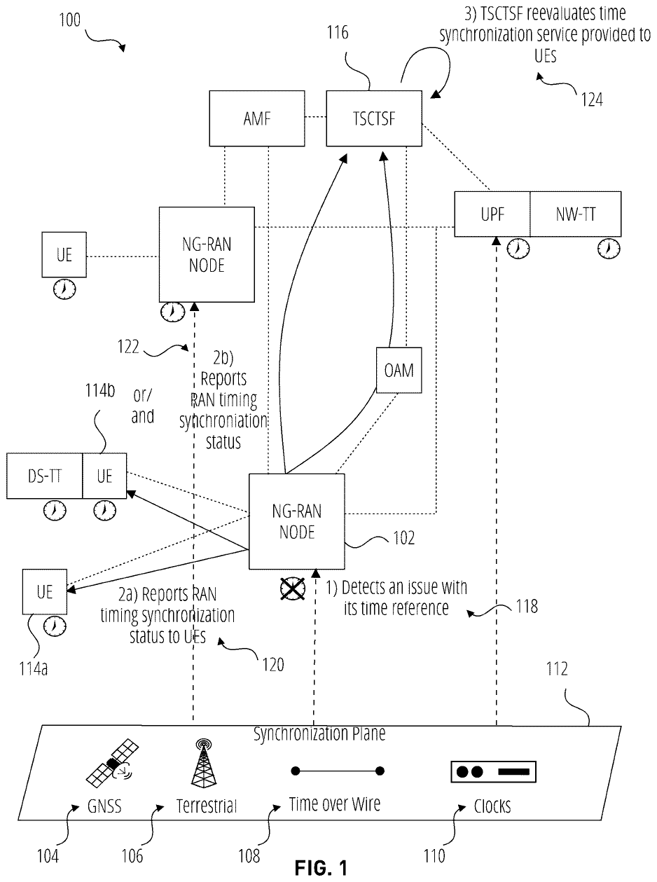

FIG. 1 illustrates a 5G timing resiliency system 100, according to embodiments discussed herein. The 5G timing resiliency system 100 may include, among other things, an NG-RAN node 102 taking timing information from one or more of a GNSS source 104, a terrestrial source 106, a time over wire source 108, and/or a clock source 110 of a synchronization plane 112, one or more UE(s) 114a and 114b, and a Time Sensitive Communication Time Synchronization Function (TSCTSF) 116.

The NG-RAN node 102 may first detect 118 an issue with its time reference (e.g., the one or more timing sources from the synchronization plane 112 that is being used). In response, the NG-RAN node 102 may report 120 an updated RAN timing synchronization status (e.g., that reflects the issue with the time reference) to one or more UE(s) 114a, 114b. Additionally or alternatively, the NG-RAN node 102 may report 122 such an updated RAN timing synchronization status to the TSCTSF 116. The TSCTSF 116 thereby enabled to reevaluate 124 time synchronization-dependent service(s) provided to one or more of the UE(s) 114a, 114b. See also 3GPP TSG RAN Meeting #99, RP-230086 (Mar. 20-23, 2023).

Some 5G networks rely on GNSS for establishing timing. Accordingly, for example, GNSS modules may be integrated at radio sites, or a GM may reside internally or externally to the 5GS, and/or timing information may be distributed within an operator's transport network via Precision Time Protocol (PTP) or other GM solutions. Timing resiliency enhancements may be used within such networks to improve a robustness of time-of-day services provided by 5G in cases of GNSS degradation/failure. Such enhancements may assist the end user in determining a preferred time source. Note that timing resiliency enhancements implemented in the 5GS may be accordingly seen as either a supplement or an alternative to the use of GNSS as a time provider.

Use cases for such timing resiliency enhancements may be found in both 5G public network customer (e.g., smart grid services, financial services) and 5G private network customer (e.g., factory use cases) contexts. Other use cases may include audio video production (AVprod, as described in 3GPP TS 22.104, version 17.3.0, annex E (July 2020); video, imaging and audio for professional applications (VIAPA), as described in 3GPP TS 22.263, version 17.4.0 (July 2021); and/or Programme Making and Special Events (PMSE), as described in 3GPP TR 22.804, version 16.3.0, section 5.8 (July 2020).

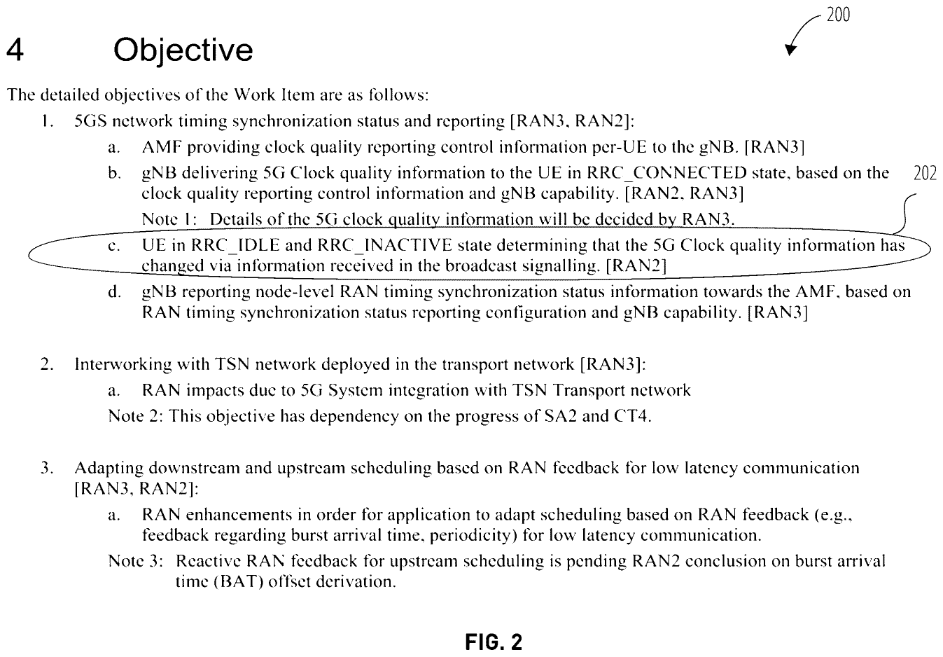

In connection with this setting, it may be beneficial to evaluate RAN impacts. FIG. 2 illustrates objectives 200 for NR timing resiliency and URLLC enhancements as may be understood in the context of various wireless communications systems. See 3GPP TSG RAN Meeting #99, RP-230754 (Mar. 20-23, 2023).

As illustrated, one objective 202 for 5GS network timing synchronization status and reporting may be to enable a UE in a radio resource control (RRC) idle (RRC_IDLE) state or an RRC inactive (RRC_INACTIVE) state to determine that applicable 5G clock quality information has changed via information received in broadcast signaling.

With respect to 5GS network timing synchronization status and reporting, it may be that UEs in RRC_INACTIVE or RRC_IDLE states receive an indication of a time synchronization status change via system information block (SIB) broadcast signaling (e.g., in an SIB 9). See 3GPP TR 23.700-25. In such cases, to retrieve/receive an accurate (and complete) time status and/or updated clock quality information, the UE may need to enter an RRC connected (RRC_CONNECTED) state, after which the gNB/base station may send time information to the UE using unicast signaling. In the RRC_CONNECTED state, it is also possible for the network to compensate for over the air propagation delay and/or to direct the UE to cells that offer the best possible time accuracy.

It may be noted that for UEs that are already in an RRC_CONNECTED state, the network can deliver updated clock quality information via dedicated signaling without the need for an RRC state change at the UE.

Details regarding the indication from the NG-RAN to the UEs of the time synchronization status change via SIB 9 are now provided. When a network timing synchronization status exceeds a threshold (which is indicative of a problematic timing status), the NG-RAN may include a reference report ID in a broadcast SIB 9. When the network timing synchronization status later meets/returns within the thresholds (e.g., a timing status improvement occurs), the NG-RAN may stop broadcasting that reference report ID in the SIB 9. In such circumstances, either event (the new use or the discontinued use of the reference report ID in SIB 9) serves as a notification for the UEs reading the SIB 9 that new clock quality information is available.

In such cases, a UE in an RRC_INACTIVE state or an RRC_IDLE state compares the reference report ID (or lack of the reference report ID) in SIB 9 with a locally stored reference report ID/reference report ID status (e.g., from/corresponding to a prior SIB 9) to determine if that UE already has the last available clock quality information. Note that in some embodiments, a reference report ID consists of a scope of the report ID and/or an event ID integer. In some cases, the indicated scope is used to support providing clock quality for all the cells within a single NG-RAN node.

If the UE is instructed by the Access and Mobility Management Function (AMF) (e.g., via a registration or a UE configuration update procedure) to reconnect to the network in cases when the UE determines that report ID has changed, the UE will leave the RRC_INACTIVE state or the RRC_IDLE state (as the case may be) and reconnect to the network (enter into an RRC_CONNECTED state). After the UE has reconnected to the network, the NG-RAN may use unicast RRC signaling to provision (updated) clock quality information to the UE.

Note that various 5GS network timing synchronization status and reporting-related conclusions may be found in 3GPP TSG SA Meeting #SP-98-e, SP-230066 (Mar. 21-24, 2023). Further, additional detail on the support of network timing synchronization status and reporting can be found in 3GPP TSG Core Network and Terminals (TSG-CT) Working Group 1 (WG1) Meeting #133-e, Change Request (CR) 3807 for TS 23.501 (Nov. 11-19, 2021) and 3GPP TSG-SA Working Group 2 (SA2) Meeting #155, CR 3892 for TS 23.501 (Feb. 20-24, 2023). See also 3GPP TSG SA Meeting #SP-98-e, SP-230052 (Mar. 21-24, 2023).

Accordingly, it may be understood that in various embodiments, to provide UEs with complete clock quality information, an NG-RAN uses unicast RRC signaling. This may occur as a matter of course for UEs already in an RRC_CONNECTED state. However, for UE(s) not in the RRC_CONNECTED state (e.g., that are in an RRC_IDLE or RRC_INACTIVE state), it may be that the UE first establishes or resumes (as the case may be) an RRC connection with the NG-RAN such that the UE can receive the clock quality information from the NG-RAN, following an indication of a time synchronization status change in an SIB 9 received at the UE.

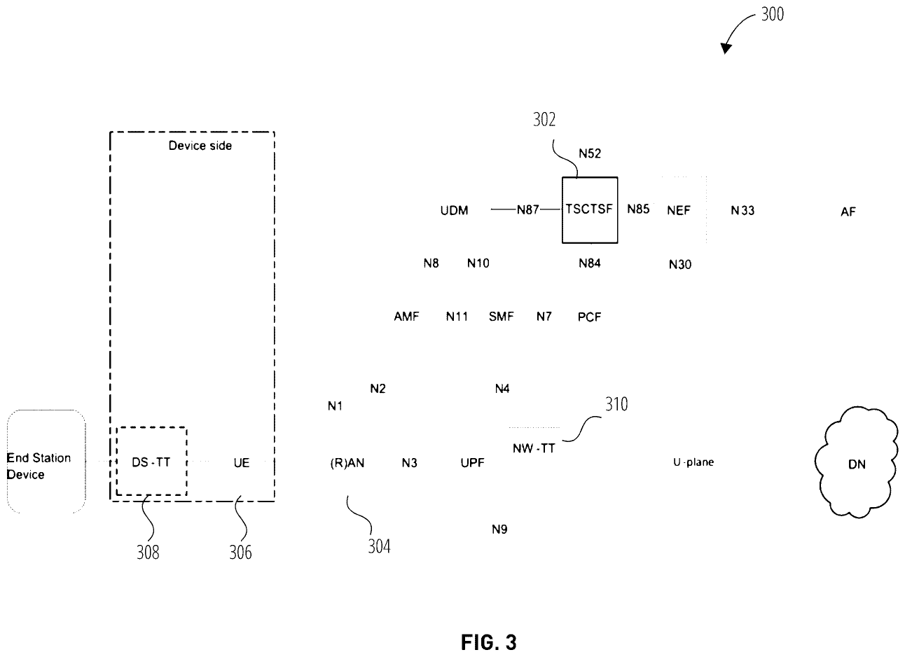

FIG. 3 illustrates a 5GS 300, according to embodiments discussed herein. As illustrated, the 5GS 300 includes, among other things, a TSCTSF 302, a RAN 304, a UE 306, a device side time sensitive networking (TSN) translator (DS-TT) 308, and a network TSN translator (NW-TT) 310.

Multiple types of time synchronization processes may supported by a 5GS. A first supported type of time synchronization process may be a 5GS synchronization. For 5GS synchronization, the access stratum (AS) (via the RAN 304) provides the 5G internal system clock to the UE 306 through the use of base station signaling. Moreover, the UE 306 may forward this 5G internal system clock as received to one or more device side time sensitive networking (TSN) translator(s) (DS-TT(s)) 308. This process may be referred to as access stratum time synchronization (ASTI).

A second supported type of synchronization process may be a (generalized) precision time protocol ((g)PTP) domain synchronization. For (g)PTP domain synchronization, the UE 306 may forward (g)PTP messages to the DS-TT 308 that is associated with a protocol data unit (PDU) session.

In some embodiments, it is considered that the elements illustrated between the DS-TT 308 and the NW-TT 310 (e.g., the 5G system as a whole) make up or act as a TSN bridge with respect to TSN functions utilized by the 5GS 300.

It has been noted that it may not be strictly/inherently necessary that a UE immediately performs a transition to RRC_CONNECTED to retrieve the latest available clock quality information upon receiving an indication that updated clock quality information is available (e.g., in SIB 9, as discussed herein). It has also been noted that in cases with relatively many UEs, simultaneous access attempts by such UEs (e.g., in response to the receipt at each UE of the indication that updated clock quality information is available) may be problematic for network capacity/congestion reasons. Accordingly, in order to reduce the number of UEs simultaneously using random access channel (RACH) access to move back to RRC_CONNECTED state to enable the receipt of updated clock quality information, it may be that the RAN causes that the UE(s) randomize their timings for re-connecting back to the network such that these connection attempts are spread in the time domain (e.g., over the course of one minute). See, e.g., 3GPP S2-2301461, TSG-SA2 Meeting #154-AH-e, CR 0002 for TR 23.700-25 (Jan. 16-20, 2023) and 3GPP SP-230066, TSG SA Meeting #SP-98-e, (Mar. 21-24, 2023).

Herein, mechanisms for causing such a spreading/distribution of UE accesses over time are discussed. Embodiments herein may anticipate that there are a large number of UEs connecting to the network out of and RRC_IDLE state or an RRC_INACTIVE state and transitioning to an RRC_CONNECTED state for obtaining updated clock quality information.

Embodiments herein relate to UE access randomization through various mechanisms. In some mechanisms, a timer based approach is use either in the AS or in the non-access stratum (NAS). Some embodiments discuss options for RRC_INACTIVE state procedures (e.g., not strictly requiring the move to an RRC_CONNECTED state as has been discussed). Some embodiments relate to RA prioritization.

According to various embodiments herein, after a UE detects a condition to obtain updated clock quality information (e.g., through a time synchronization status change via SIB 9 broadcast signaling, a time service quality degradation, and/or the indicated availability of a configuration update), a UE in RRC_IDLE or RRC_INACTIVE may perform at least one of following actions for the purpose of time synchronization:
Option 1: Enter an RRC_CONNECTED state via an RRC connection establishment procedure;
Option 2: Resume an existing RRC connection via an RRC connections resume procedure;
Option 3: Stay in an RRC_INACTIVE state (if small data transmission (SDT) is supported and small data transmission is possible);
Option 4: Inform the NAS layer about the time synchronization status change; and/or
Option 5: Inform the DS-TT about the time synchronization status change.

In other words, embodiments herein disclose methodologies that may be understood to be useable/combinable in conjunction with one or more of the options above.

### Embodiments of AS-Timer-Based UE Access Randomization

In various embodiments, it may be that a UE is triggered to perform an RRC connection establishment procedure or an RRC connection resume procedure in order to enter an RRC_CONNECTED state to obtain updated clock quality information. In some such embodiments, if the UE has a stored AS wait_time parameter, the UE may generate a random time value that is between zero and the AS wait_time parameter. Then, the UE may start a timer with the generated random time value. While the timer is running, the UE may refrain from initiating an RRC connection establishment procedure or an RRC connection resume procedure for the purpose of clock quality information retrieval. Upon expiration of the timer, the UE may proceed to then trigger an RRC connection establishment procedure or an RRC connection resume procedure if the trigger condition is still valid (e.g., the reference report ID in SIB 9 still indicates that the UE's clock quality information is not up-to-date).

In cases where an RRC connection establishment procedure or an RRC connection resume procedure for a purpose other than clock quality information retrieval is triggered at the UE while the described timer is running, the UE may establish/resume the RRC connection, optionally indicate a request for updated clock quality information retrieval as part of that establishment/resumption, and stop the timer.

Note that the name “wait_time” for the AS parameter is given by way of example and not by way of limitation. It is anticipated that other names for a parameter having analogous functionality may be instead be used in some wireless communication systems. In general, the AS wait_time parameter may be understood as one example of a maximum clock quality information retrieval wait time that is used for AS-timer-based UE access randomization contexts as described.

The value of the AS wait_time parameter may be determined based on at least one of the following options:
Fixed/a default value (e.g., per a specification for the wireless communication system);
Configured by the RAN;
Pre-programmed in the device based on operator preferences;
Configured by the network during RRC reconfiguration;
Configured by the network in another RRC procedure (e.g., an RRC setup procedure, an RRC resume procedure, an RRC release procedure, a DLInformation Transfer procedure, etc.); or
Configured by the network via system information (SI) broadcast.

### Embodiments of NAS-Timer-Based UE Access Randomization

In some embodiments, a UE-initiated NAS transaction for clock quality information retrieval is used.

In a first alternative, if the UE has a stored NAS wait_range parameter, the UE may generate a random time value that is between zero and the NAS wait_range parameter. Then, the UE may start a timer with the generated random time value. While the timer is running, the UE may refrain from initiating registration for the purpose of clock quality information retrieval. Upon expiration of the timer, the UE may perform a registration procedure for clock quality information retrieval in the case that the UE remains camped on the selected public land mobile network (PLMN)/network slice/tracking area/registration area, or the cells associated with the time domain that it was camping on when the timer was started.

If another registration (e.g., for a purpose other than clock quality information retrieval) is triggered while the described timer is running, the UE may initiate a registration, include a request for updated clock quality information retrieval as part of that registration, and stop the timer. If the request for updated clock quality information retrieval cannot be or is not included in this alternatively-triggered registration procedure, the UE may instead leave the timer running and initiate a (second) registration procedure with a request for updated clock quality information retrieval upon expiration of the timer.

A second alternative follows generally the first alternative, but instead of registration, another NAS procedure (e.g., a procedure for initiating an uplink (UL) message from the UE) is used. Examples of such NAS procedures may include, but are not limited to, a DS-TT-initiated port management procedure, a DS-TT initiated port management capability procedure, a UE-requested PDU session establishment procedure (e.g., for port management information and DS-TT residence time), a UE-requested PDU session modification procedure, a UL NAS TRANSPORT procedure, and/or a service request procedure.

In a third alternative, if the UE has a stored NAS wait_range parameter, the UE may generate a random time value between zero and the NAS wait_range parameter. Then, the UE may start a timer with the generated random time value. While the timer is running, the UE shall not initiate registration on a selected PLMN or optionally on a selected slice (based on a network slice selection assistance information (NSSAI)) except if/unless the UE needs to request an emergency PDU session. In such a case where an emergency PDU session is needed while the timer is running, the UE shall initiate a registration procedure, set the 5GS registration type information element (IE) to “emergency registration” in the registration request message, and keep the timer running.

Upon expiration of the timer, if the UE does not (e.g., still) have an emergency PDU session, the UE shall perform a registration procedure for clock quality information retrieval in the case that the UE remains camped on the selected PLMN/network slice that it was on when the timer was started. If the UE (e.g., still) has an emergency PDU session when the timer expires, the registration procedure for clock quality information retrieval services may be performed after the release of the emergency PDU session, in the case that the UE remains camped on the selected PLMN/network slice.

Note that the name “wait_range” for the NAS parameter is given by way of example and not by way of limitation. It is anticipated that other names for a parameter having analogous functionality may be instead be used in some wireless communication systems. In general, the NAS wait_range parameter may be understood as one example of a maximum clock quality information retrieval wait time that is used for NAS-timer-based UE access randomization contexts as described.

The value of the NAS wait_range parameter may be determined based on at least one of the following options:
Fixed/a default value (e.g., per a specification for the wireless communication system);
Configured by the core network (CN);
Pre-programmed in the device based on operator preferences;
Configured by the network during a registration procedure;
Configured by the network during a PDU Session establishment/modification (e.g., for a network slice);
Configured by the network during a UE configuration update procedure;
Configured by the network during a port management procedure; or
Configured by the network during a user plane (UP) node management procedure.

It may be noted that as an optional embodiment, the NAS wait_range parameter may be defined as applicable based on a time synchronization domain or a time synchronization area impacted. For example, the NAS wait_range parameter applicability could be based on a coverage area for time synchronization service (e.g., associated with a TSCTSF subscription), which may contain a list of Tracking Areas (TAs) or a geographical areas (e.g. civic addresses or shapes that a network exposure function (NEF) transforms to list of TAs based on pre-configuration). The NAS wait_range parameter could be valid also for one or multiple network slices, a PLMN or list of PLMNs, one or multiple tracking areas, and/or associated with a registration area in various embodiments.

### Embodiments of Time Synchronization Update in RRC_INACTIVE State

In some cases, an update of time synchronization information (including clock quality information) could be achieved at the UE without the UE first entering into the RRC CONNECTED state. For example, if the UE supports small data transmission (SDT), the network may directly send a DLInformationTransfer message to a UE in that is in the RRC_INACTIVE state. The DLInformationTransfer message may contain relevant time synchronization information, such as a referenceTimeInfo IE and/or information about propagation delay compensation (PDC), such as an rxTxTimeDiff-gNB parameter and/or a ta-PDC parameter. Additionally to these objects, a DLInformationTransfer message may be extended with new parameters for clock quality and time synchronization update purposes. Moreover, the DLInformation Transfer message may carry a DedicatedNAS-Message field, which may contain further time synchronization information (e.g., including clock quality information) directly from the CN (e.g., originating from a TSN AF, a TSCTSF, a session management function (SMF), a policy control function (PCF), or an AMF).

Likewise, a UE in an RRC_INACTIVE state may initiate, during SDT, a UL information transfer procedure (using a ULInformationTransfer message and/or a DedicatedNAS-Message field), for example, when there is a need to transfer NAS dedicated information related to time synchronization to the CN. Such a transaction may be triggered by higher layers.

### Embodiments of Random Access Prioritization

In some embodiments, a RACH configuration that considers an access identity that is particular to UE access for clock quality information retrieval may be used. In order to support RACH prioritization for an access identity for UE access for clock quality information retrieval (e.g., a new access identity for this purpose), sets of a scalingFactorBI object and a powerRampingStepHighPriority object may be configured in SI.

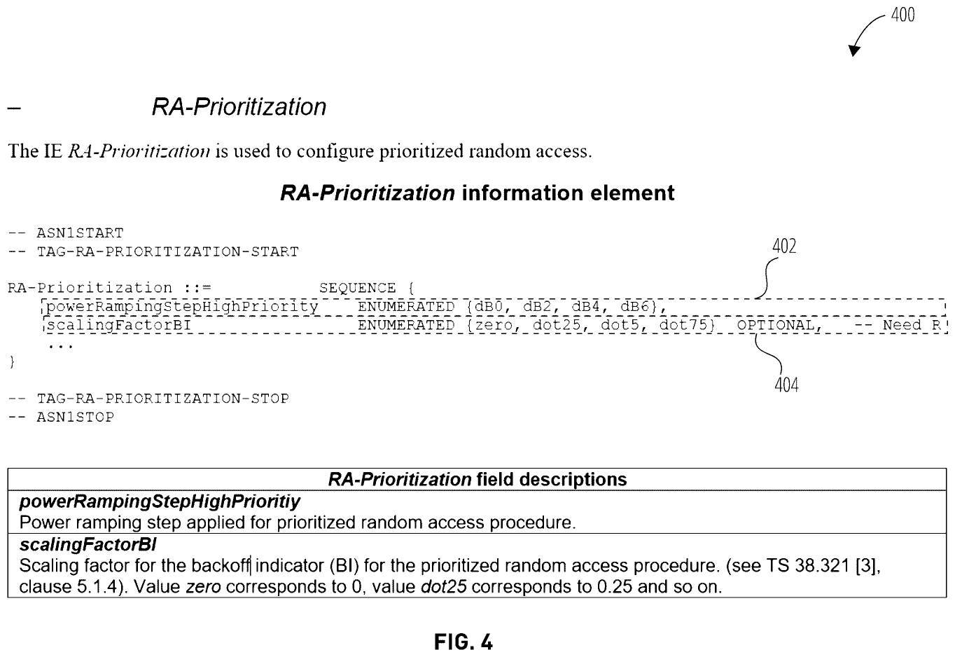

For some wireless communication systems, a specification (e.g., for RRC) may contain an option for prioritized random access (RA) through the use of an RA-Prioritization IE. FIG. 4 illustrates an RA-prioritization IE 400 that accounts for the use of an access identity for UE access for clock quality information retrieval, according to embodiments herein. As illustrated, the RA-prioritization IE 400 includes a powerRampingStepHighPriority object 402 and a scalingFactorBI object 404.

An RA-prioritization IE may be configured in one or more of several other IEs used by the wireless communication system (e.g., in SI). By including an RA-Prioritization IE in various configuration scenarios, it is possible to parameterize the random access procedure of the UE with multiple sets of powerRampingStepHighPriority and scalingFactorBI in order to allow for prioritized random access, where a powerRampingStepHighPriority is a power ramping step that is applied for prioritized random access procedures, and where scalingFactorBI is a scaling factor for a backoff indicator (BI) for a prioritized random access procedure.

With respect to UE access for clock quality information retrieval, it may be that a dedicated set of one or more RA-Prioritization IEs for a new access identity (e.g., Access Identity 4) are configured in order to introduce dedicated RA parameterization for this access identity. This configuration may be done separately for each of a 4-step RA context and a 2-step RA context. Note that while disclosure and/or figures herein may assume that the new access identity is called “Access Identity 4,” it should be generally understood that this particular name for the new access identity is given by way of example and not by way of limitation in such examples.

Then, the new access identity for UE access for clock quality information retrieval may accordingly be provided different ‘weight’ for/of prioritization of on a given carrier as compared to a weight for/of RAs for other types of traffic/UE access procedures. For example, accesses requests for clock quality information retrieval could get a lower/higher/different priority than other access requests. In this manner, relative parameterization between UE access for clock quality information retrieval and other types of/reasons for UE access may be achieved.

In other embodiments of random access prioritization, one or more RA-Prioritization IEs could be implemented as described, but outside any access identity context. In such cases, it may be that UE determines to use these one or more RA-Prioritization IEs based on a UE notion/determination that the access is for time synchronization update purposes (e.g., that is made apart from any formal access identity-based analysis). The UE determination may be based on, for example, a network configuration that enables or disables the use of the one or more RA-Prioritization IEs. Note also that a use of one or more RA-Prioritization IEs may in some cases be based on/may depend on a definition for (e.g., in a specification for) the wireless communication system.

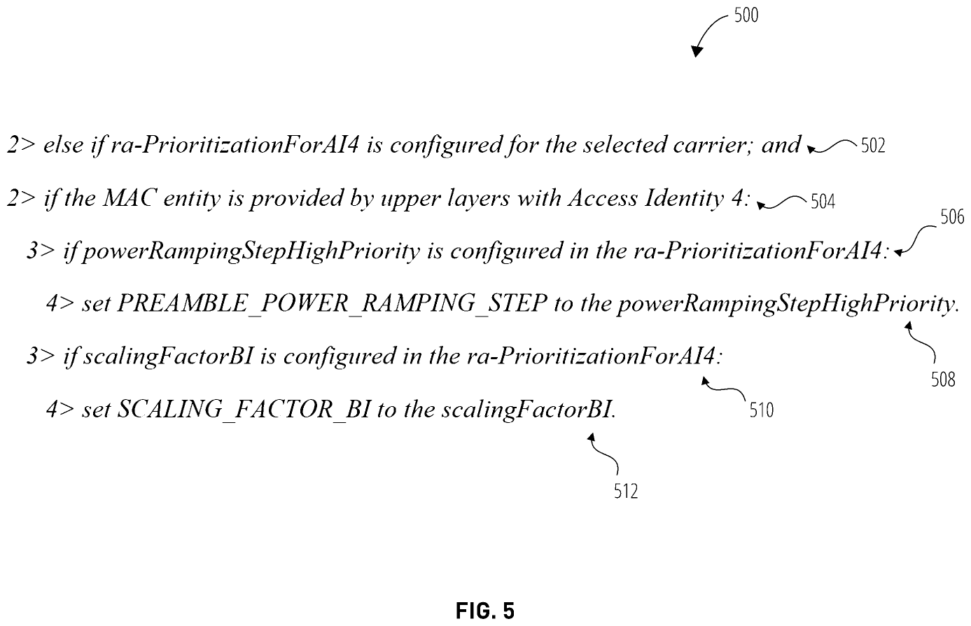

FIG. 5 illustrates a portion 500 of a procedure for initialization of variables specific to an RA type that accounts for the use of a new access identity used for UE access for clock quality information retrieval, according to embodiments discussed herein.

First, a UE first determines 502 that the selected carrier is configured with an IE for the use with the new access identity, and further determines 504 that a medium access control (MAC) entity of the UE is provided by upper layers with the new access identity.

If these are each the case, the UE proceeds to check 506 whether a power ramping step is configured in the IE. If so, the UE sets 508 the power ramping step used for UE access for clock quality information to this power ramping step.

Further, if these are each the case, the UE also proceeds to check 510 whether a scaling factor for a BI is configured in the IE. If so, the UE sets 512 the BI scaling factor used for UE access for clock quality information to this scaling factor.

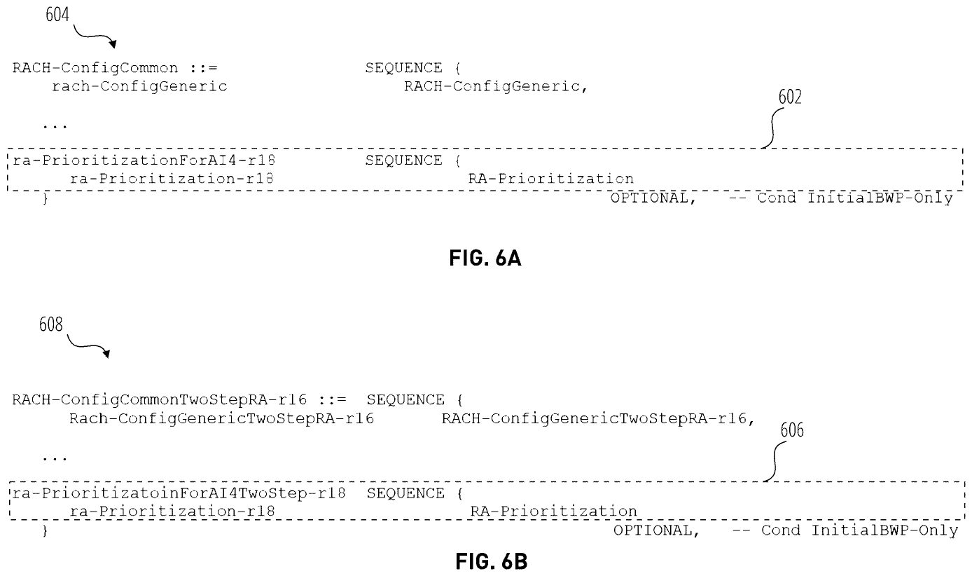

FIG. 6A illustrates a new ra-PrioritizationForAI4-r18 field 602 that may be inserted in a RACH-ConfigCommon IE 604, and that may be applicable to the use of the new access identity used for UE access for clock quality information retrieval within some wireless communication systems.

FIG. 6B illustrates a new ra-PrioritizationForAI4TwoStep-r18 field 606 that may be inserted in a RACH-ConfigCommonTwoStepRA-r16 IE 608, and that may be applicable to the use of the new access identity used for UE access for clock quality information retrieval within some wireless communication systems.

It may be noted that within some definitions for some wireless communication systems (e.g., some NR systems), a field ra-PrioritizationFor AI-r16 is defined as “SIZE (2)” and applies for prior access identities (e.g., Access Identity 1 and 2 in some NR systems).

Therefore, a similar configuration to those otherwise discussed herein could be achieved by extending the existing structure (e.g., for the field ra-PrioritizationForAI-r16) to a larger SIZE value and by allowing additional access identities to use it. Note that this may cause that all access identities share the same configuration.

### Embodiments of UAC Extensions for Clock Quality Information Retrieval

In some wireless communications systems, UE access for clock quality information retrieval may be randomized through unified access control (UAC) mechanisms. In such cases, it may be that a separate UE capability is used. It is anticipated that solutions utilizing U AC to distribute/randomize a UEs' access(es) in time may support cases of a large number of UEs connecting to the network out of RRC_IDLE or RRC_INACTIVE states and transitioning to RRC_CONNECTED for obtaining updated clock quality information.

In some wireless communication systems, UAC allows the system to prevent UEs that use selected access categories and/or access identities from sending initial access messages, such that load control may be managed. In UAC-enabled systems, an access request may be associated with one access category, which relates to a service type corresponding to the access, and one or more access identities, which may be associated with a UE profile stored in the universal subscriber identity module (USIM) during data provisioning.

Then, a UAC check may be applied by/at a UE (e.g., with respect to all RRC states) when the UE wants to initiate a new network access attempt. To perform a UAC check, the UE maps its access attempt to an access category and one or more access identity(s) based on defined mapping rules (e.g., in NAS). See, e.g., 3GPP TS 22.261, version 19.2.0 (March 2023) and 3GPP TS 24.501, version 18.1.0 (March 2023).

The UE then checks if the access request is barred for the given cell by evaluating the barring information for the cell sent in an SIB 1 message in view of the applicable access category and access identity(s). For example, the NAS may indicate an access category and/or one or more access identities to the AS. At the UE, RRC checks whether the network access is allowed for the access category and the access identity associated with the UE's access request. Note that in NR wireless communication systems, this UAC check may be applied with respect to all RRC UE states (RRC_IDLE state, RRC_INACTIVE state, and RRC_CONNECTED state). If the access request is not barred, the access request is sent; otherwise, the access request is not sent.

The network may dynamically configure barring information for each request attempt type, thereby enabling the system to take into account a desired accessibility prioritization by a network operator.

In some cases, the base station broadcasts barring control information associated with access categories and access identities. Then the UE determines whether an access attempt is authorized based on the barring information broadcast for the selected PLMN, and the selected access category and access identity for the access attempt. For NAS triggered requests, the NAS determines the access category and access identity. For AS triggered requests, the RRC determines the access category while NAS determines the access identity.

With respect to RRC-related determinations, the UE may be able to determine whether or not a particular new access attempt is allowed based on a uac-BarringInfo object broadcast in SIB 1. An access control check may be performed as per the information received in uac-BarringInfoSetList. See, e.g., 3GPP TS 38.331, version 17.4.0, clause 5.3.14 (March 2023).

Each UAC access category may be configured with parameters corresponding to a particular set of access control parameters through the use of a uac-barringInfoSetIndex value. The parameters are specified by providing an index to the set of configurations (e.g., a uac-barringInfoSetList object). Note that in some cases, an association of an access category with a uac-barringInfoSetIndex value that has no corresponding entry in the uac-BarringInfoSetList object may be considered a valid configuration that indicates no barring.

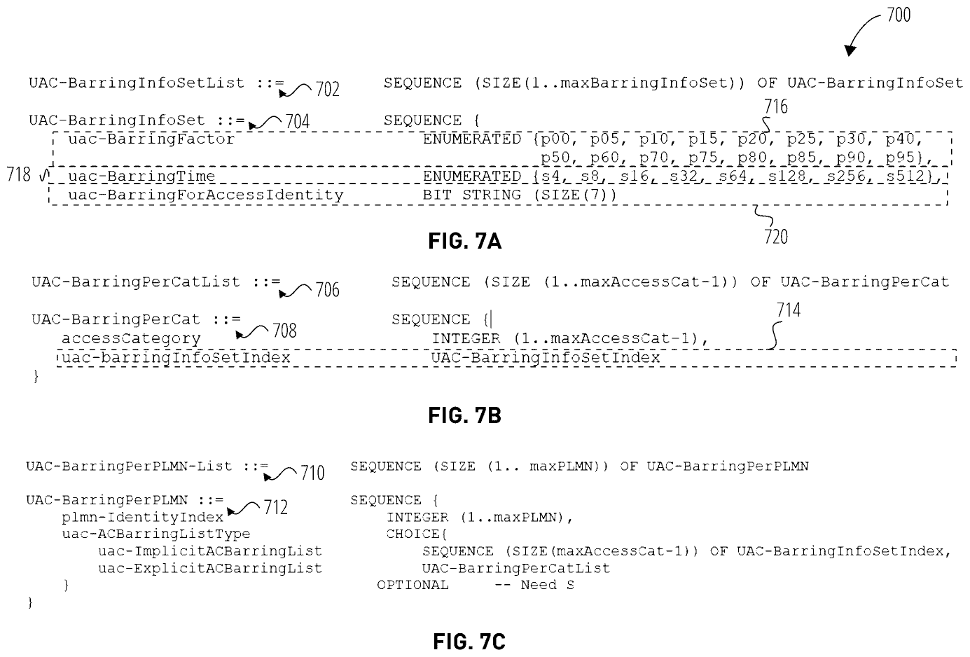

FIG. 7A illustrates definitions 700 for a UAC-BarringInfoSetList IE 702 and a UAC-BarringInfoSet IE 704 that may be used in various wireless communications systems. FIG. 7B illustrates definitions for a UAC-BarringPerCatList IE 706 and a UAC-BarringPerCat IE 708 that may be used in various wireless communication systems. FIG. 7C illustrates definitions for a UAC-BarringPerPMLNList IE 710 and a UAC-BarringPerPLMN IE 712 that may be used in various wireless communication systems.

A UAC-BarringInfoSetList IE 702 may include one or more UAC-BarringInfoSet IEs 704, with each such UAC-BarringInfoSet IE 704 corresponding to one access category.

Each applicable access category may be configured with access parameters by assigning that access category a correspondence to a particular UAC-BarringInfoSet IE 704 in a UAC-BarringInfoSetList IE 702 through the use of a uac-barringInfoSetIndex value 714 in a UAC-BarringPerCat IE 708 of a UAC-BarringPerCatList IE 706, as illustrated.

For each UAC-BarringInfoSet IE 704 (e.g., access category) in the UAC-BarringInfoSetList IE 702, corresponding barring information may include a barring factor 716, a barring time 718, and a barring indicator 720 for each of the access identities. The barring indicator 720 (e.g., a uac-BarringForAccessIdentity parameter) may indicate whether an access attempt is allowed for each access identity.

Each entry in the UAC-BarringInfoSetList IE 702 may be further configured with an access probability and a ‘wait time’ after an access was barred during the RRC's access barring check. The barring factor 716 (e.g., a uac-BarringFactor parameter) indicates the probability that a given access request may be allowed. The barring time 718 (e.g., a uac-BarringTime parameter) defines a minimum time interval before an access attempt may be re-attempted after a prior attempt was barred.

Disclosure herein relates to the use of UAC in a manner that allows for differentiation in treatment between UE access signaling initiated for clock quality information updating and other mobile originated (MO) signaling by the UE.

In various cases, a wireless communication system may randomize the UE accesses through a new UAC access identity, which may be associated with UAC parameters that are configured by the network to spread UE connection requests in time. Such solutions may have impacts on one or more of service requirements, the RRC layer, UE procedures in RRC_IDLE state/RRC_INACTIVE state, and/or the NAS.

In a first set of solutions, access attempts related to clock quality information retrieval are associated with a new access identity (e.g., Access Identity 4). To control the load that the UE access attempts for clock quality information retrieval put on a cell, the cell may broadcast access control parameters in SIB 1 for the UEs that support, depend upon, and/or make use of timing resiliency embodiments disclosed herein (which may be used in conjunction with the clock quality information in SIB 9 as is discussed herein). The network then sets the access control parameters for Access Identity 4 (in SIB 1) so that the access attempts for clock quality information retrieval (from relevant UEs) are more likely to be barred (or may be otherwise differently controlled) compared to other types of UEs or other access identities. The mechanism controls network access by UEs based on their assigned access identity, which may be part of subscription data and/or stored user data on a USIM.

Alternatively, a the UE may use the new access identity when it is connected to a DS-TT and clock quality information update/retrieval is required, and/or when a 5G session management (5GSM) capability IE indicates that transfer of port management information containers is supported through the transfer of port management information containers (TPMIC) bit.

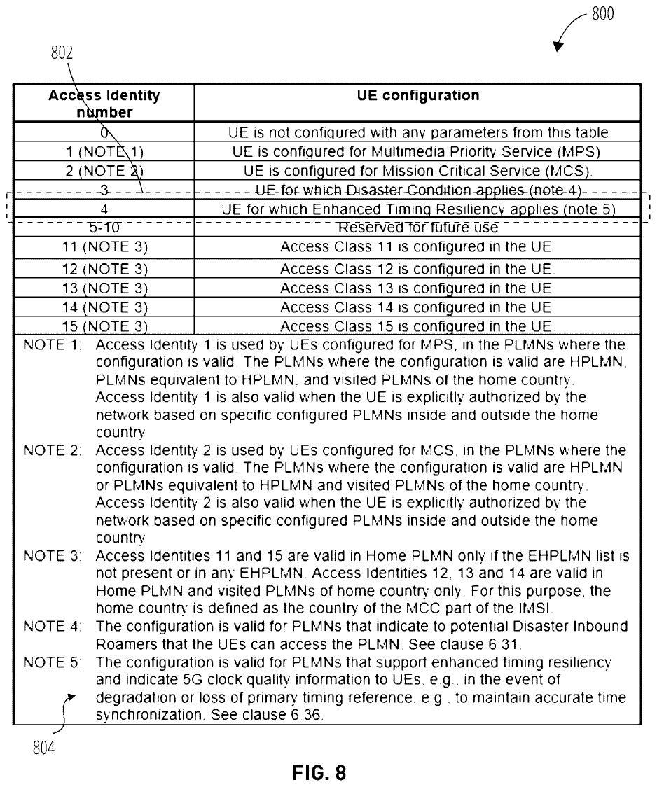

FIG. 8 illustrates a table 800 for an access identity 802 associated with access attempts related to clock quality information retrieval, according to embodiments discussed herein. The access identity 802 of the table 800 could be used in, for example, a 5G system that supports the use of the access identity 802 to randomize the access from UEs in RRC_IDLE and RRC_INACTIVE states, as is discussed herein.

Further, as noted 804 in the table 800, for NR wireless communication systems, it may be that a configuration using the access identity 802 is valid for PLMNs that support enhanced timing resiliency and indicate 5G clock information to UEs, e.g., in the event of degradation or loss of a primary timing reference, for purposes of maintaining accurate time synchronization.

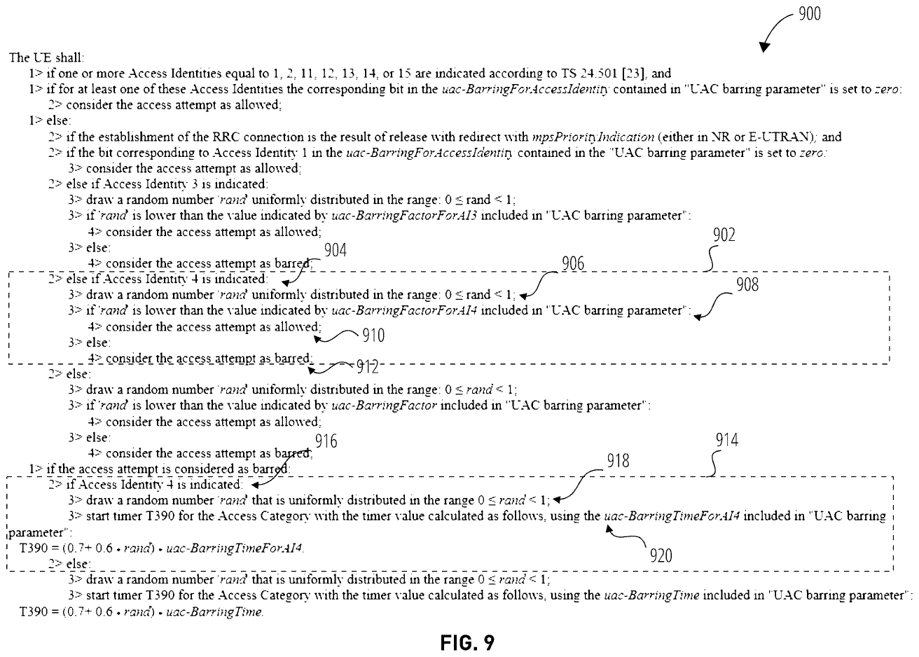

FIG. 9 illustrates a procedure 900 of a UE for using an access identity associated with access attempts related to clock quality information retrieval, according to embodiments disclosed herein. A first portion 902 of the procedure 900 corresponds to a case 904 where the new access identity is indicated. In such a case, the UE draws 906 a random number between 0 and 1. This random number may be selected using a uniform distribution between 0 and 1. The UE then determines 908 whether the random number is lower than a barring factor for the new access identity. If so, the UE considers 910 the access attempt as allowed and performs the access attempt. If not, the UE considers 912 the access attempt as barred and does not perform the access attempt.

A second portion 914 of the procedure 900 corresponds to a case 916 where the new access identity is indicated and the UE has already determined that an access request is barred. In such a case, the UE draws 918 a random number between 0 and 1. This random number may be selected using a uniform distribution between 0 and 1. The UE then starts 920 a timer (e.g., a T390 timer) with a value that is calculated using the random number and a barring time for the new access identity (e.g., using the formula illustrated in FIG. 9).

Various UAC-related parameters for the use of timing resilience features discussed herein with respect to RRC functionality are now discussed. The use of such parameters in conjunction with the new access identity allows for a particular configuration with respect to the randomization of UE access signaling for clock quality information updating as discussed herein.

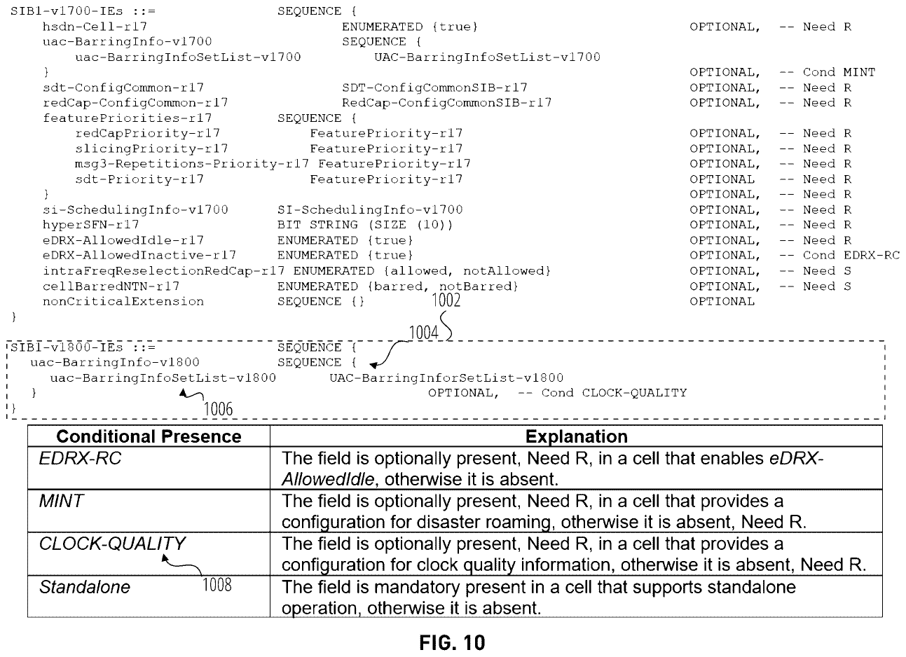

FIG. 10 illustrates a SIB1-v1800-IE listing 1002 having extended barring information for UAC contexts, as may be broadcast in wireless communication systems implementing embodiments discussed herein. In such wireless communication systems, a uac-BarringInfo-v1800 IE 1004 of a SIB1-v1800-IE listing 1002 may contain a uac-BarringInfoSetList-v1800 IE 1006, as illustrated. The use of the information in the SIB1-v1800-IE listing 1002 may be conditional on whether the timing resilience feature is being used in a cell (as may be indicated by a CLOCK-QUALITY field 1008, as illustrated).

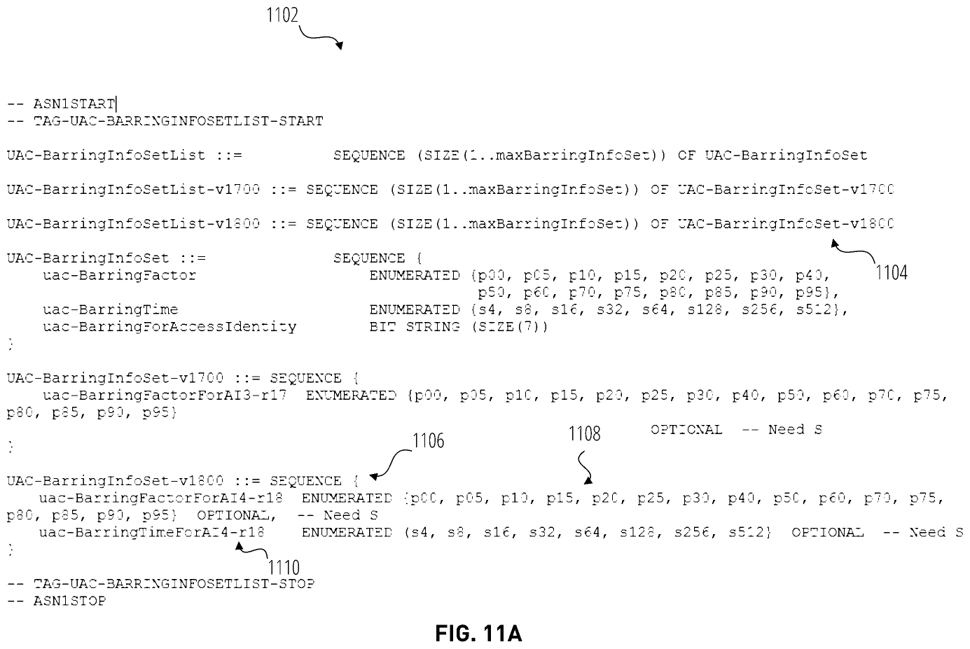

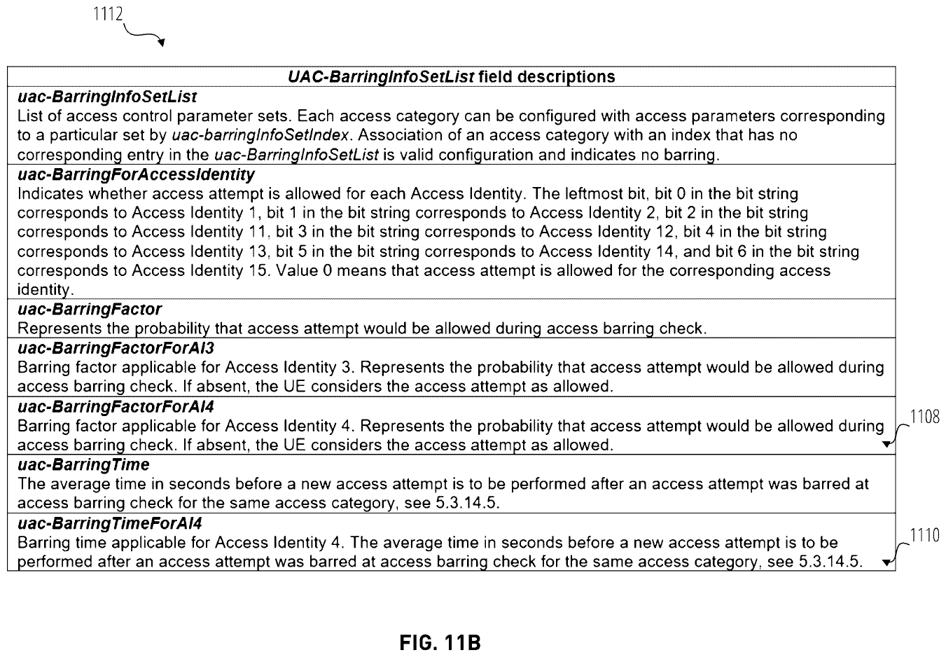

FIG. 11A illustrates a definition 1102 for a uac-BarringInfoSetList-v1800 IE 1104, as may be used in wireless communication systems implementing embodiments discussed herein. As shown, the uac-BarringInfoSetList-v1800 IE 1104 may include one or more UAC-BarringInfoSet-v1800 IEs 1106, where each UAC-BarringInfoSet-v1800 IE 1106 includes a barring factor 1108 and/or a barring time 1110 corresponding to the use of the new access identity.

FIG. 11B illustrates descriptions 1112 for each of the barring factor 1108 and the barring time 1110 as may be used within the uac-BarringInfoSetList-v1800 IE 1104. As illustrated, the barring factor 1108 relates a barring factor applicable when using the new access identity, and may be a probability that an access attempt will be allowed during an access barring check. In some embodiments, if the barring factor 1108 is absent, the UE considers the access attempt as allowed.

Further, the barring time 1110 relates a barring time applicable when using the new access identity, and may be the average time (e.g., in seconds) before the UE may re-attempt an access after a prior access attempt was barred at the access barring check for the new access category.

In some wireless communication systems, for a UEs assigned to the new access identity that are in an RRC_IDLE or an RRC_INACTIVE state, when a cell status is indicated as “not barred” and “reserved” for operator use for any PLMN and/or standalone non-public network (SNPN) and not “true” for other use and not “true” for future use, the UE may behave as if the cell status is “barred” in case the cell is “reserved for operator use” for the registered PLMN or the selected PLMN. Note that the new access identity may, in some cases, only be valid for PLMNs that indicate that UEs may access the PLMN to retrieve updated clock quality information for timing resiliency purposes.

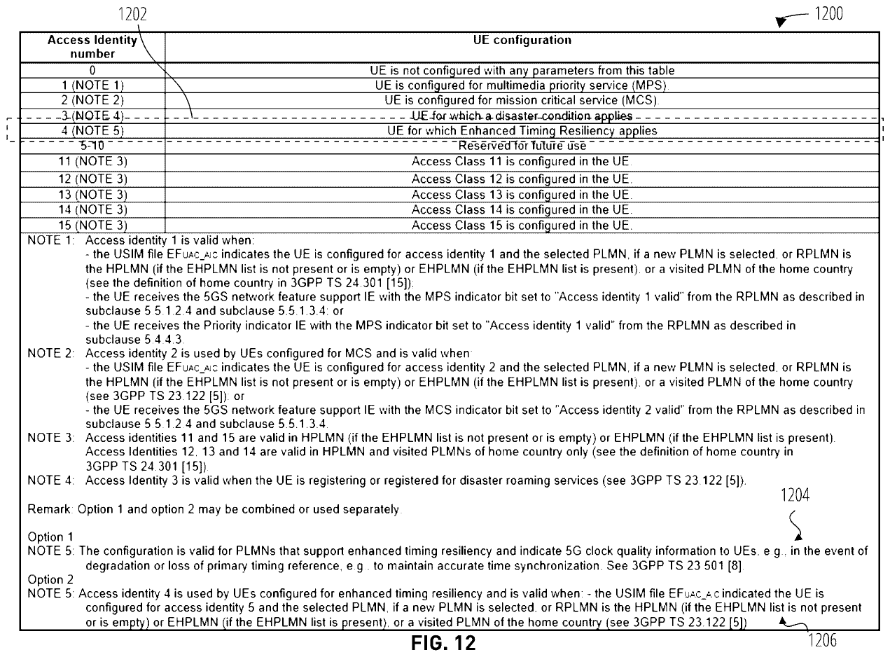

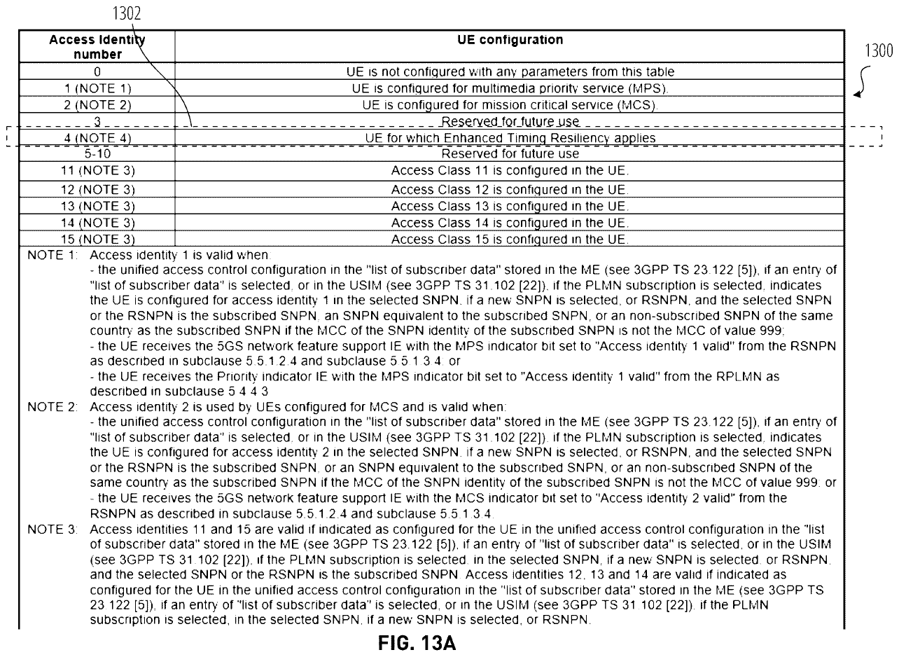

FIG. 12 illustrates a table 1200 for an access identity 1202 associated with access attempts related to clock quality information retrieval in an NAS context, according to embodiments discussed herein. The access identity 1202 of the table 1200 could be used in, for example, a 5G system that supports the use of the access identity 1202 to randomize the access from UEs in RRC_IDLE and RRC_INACTIVE states, as is discussed herein. The access identity 1202 of the table 1200 (and a corresponding access category) could be used/determined by a UE that is not operating in an SNPN mode.

Further, as noted 1204 in the table 1200, such a configuration may be valid for PLMNs that support enhanced timing resiliency and indicate clock information to UEs, e.g., in the event of degradation or loss of a primary timing reference, for purposes of maintaining accurate time synchronization.

As also noted 1206 in the table 1200, the new access identity may be used by UEs configured for enhanced timing resiliency and may be valid when a USIM file EF_{UAC_AIC} indicated in/by the UE is configured for another particular access identity (e.g., access identity 5) and the selected PLMN (if a new PLMN is selected) or registered PLMN (RPLMN) is the home PLMN (HPLMN) (if an equivalent home PLMN (EHPLMN) list is not present or is empty), the EHPLMN (if the EHPLMN list is present), or a visited PLMN of the home country.

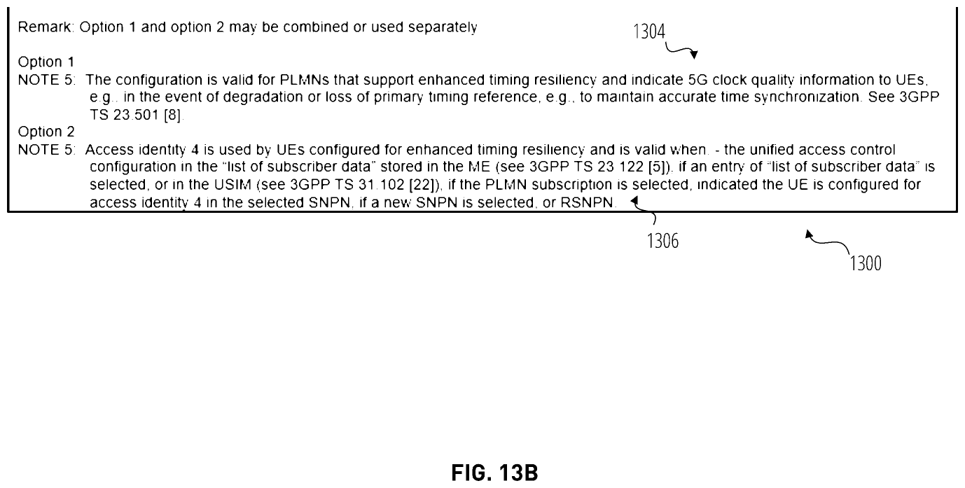

FIG. 13A and FIG. 13B together illustrate a table 1300 for an access identity 1302 associated with access attempts related to clock quality information retrieval in an NAS context, according to embodiments discussed herein. The access identity 1302 of the table 1300 could be used in, for example, a 5G system that supports the use of the access identity 1302 to randomize the access from UEs in RRC_IDLE and RRC_INACTIVE states, as is discussed herein. The access identity 1302 of the table 1300 (and a corresponding access category) could be used/determined by a UE that is operating in an SNPN mode.

Further, as noted 1304 in the table 1300, such a configuration may be valid for PLMNs that support enhanced timing resiliency and indicate clock information to UEs, e.g., in the event of degradation or loss of a primary timing reference, for purposes of maintaining accurate time synchronization.

As also noted 1306 in the table 1300, the new access identity may be used by UEs configured for enhanced timing resiliency and may be valid when a unified access control configuration in the “list of subscriber data” stored in the mobile equipment (ME), if an entry of “list of subscriber data” is selected, or in the USIM, if the PLMN subscription is selected, indicates that the UE is configured for the new access identity in the selected SNPN, if a new SNPN is selected, or in the registered SNPN (RSNPN).

In some embodiments, a new rule may be defined to determine an access category applicable for the access attempt for the purpose of clock quality information retrieval.

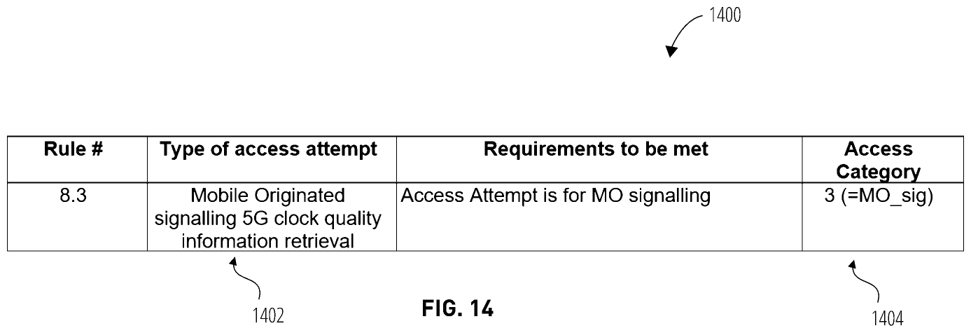

FIG. 14 illustrates a first option for a rule 1400 for a mapping table used to determine access categories in a NAS context, as may be used in wireless communication systems discussed herein. The rule 1400 may be added to, for example, 3GPP TS 24.501, version 18.2.1, table 4.5.2.2 and/or table 4.5.2A.2 (March 2023) as may be used to define aspects of some NR systems. As illustrated, under the rule 1400 of this first option, an access attempt 1402 for clock quality information retrieval may be mapped to an existing access category 1404 (e.g., an access category that is not the new access category, such as Access Category 3 in some NR systems, as shown by way of example in FIG. 14).

In a second option for a rule for a mapping table used to determine access categories, an access attempt for clock quality information retrieval may be mapped instead to a separate/new access category.

Discussion related to such a new/separate access category now follows. UE accesses for the purpose of clock quality information retrieval may be randomized through the use of a separate/new UAC access category that is associated with UAC parameters configured by the network for spreading UE connection requests in time. In some cases, the new access category may be formally defined for this use in a specification controlling the operation of the wireless communication system. Alternatively, such an access category that is based on an operator classification could be used.

In such circumstances, access attempts for clock quality information retrieval may associated with the separate access category based on service and NAS layer specifications. To control the load that UE access attempts for clock quality information retrieval put on a cell, the cell may broadcast access control parameters in SIB 1 for the UEs that support, depend upon, or make use of NR timing resiliency embodiments discussed herein (which may be used in conjunction with the clock quality information in SIB 9). The network sets access control parameters in SIB 1 for the respective access category (e.g., in a UAC-BarringPerCatList IE), so that the access attempts for clock quality information retrieval (from relevant UEs) may be separately controlled compared to other types of UE access categories. This mechanism as described controls network access of UEs based on a standardized or operator-defined access category.

Alternatively, a UE may use the access category when it is connected to a DS-TT and clock quality information update/retrieval is required, and/or when a 5GSM capability IE indicates that transfer of port management information containers is supported through a TPMIC bit.

In some embodiments, the UE may be configured to make a UE capability indication related to the use of access attempts for clock quality information retrieval. In some cases, the UE may be able to make an AS-related capability indication. In such cases, the UE may indicate support for clock quality information retrieval/enhanced timing resiliency as described herein For some NR networks, this functionality may be defined in, for example, an update to 3GPP TS 38.306.

In some cases, the UE may be able to make a NAS-related capability indication. A port management capability may be sent by the DS-TT to provide DS-TT-supported port management capabilities to the TSN AF, and which includes a port management capability IE. The UE may indicate support for enhanced timing resiliency in this IE. Note that for some NR networks, this functionality may be defined in, for example, an update to 3GPP TS 24.519 and/or TS 24.539.

As discussed herein, various trigger events causing a UE to attempt to retrieve updated clock quality information may occur. For example, when a time synchronization service degradation occurs (e.g., due to a master clock outage or another event), UEs in an RRC_IDLE state and/or an RRC_INACTIVE state may need to reconnect to the network (enter an RRC_CONNECTED state) in order to receive updated clock quality information via RRC unicast signaling. Further, when the time synchronization service is restored, UEs in an RRC_IDLE state or an RRC_INACTIVE state may again need to reconnect to the network to enter the RRC_CONNECTED state for reception of updated clock quality information via RRC unicast signaling. For example, an NG-RAN node or base station may stop broadcasting a reference report ID in an SIB (e.g., SIB 9). It is also possible that a time synchronization service is “restored” for the purpose of utilizing a comparatively better yet different master clock than a prior master clock. Alternatively, an SIB (e.g., SIB 9) may show another reference report ID update.

In response to each/any of the above events, it may be the case that a large number of UEs may simultaneously attempt to access the network unless affirmative steps to spread out such accesses are taken (as discussed herein). It is therefore anticipated that not only service degradation events, but also a service restoration events and/or service “switch” events may cause an overload situation. Accordingly, while examples scenarios herein may discuss situations involving a service degradation at the UE, it is contemplated that methods discussed herein could also be usefully applied with respect to instances of service restoration and/or service switch as well.

It is noted that the various embodiments described herein can be applied jointly (combined) or applied separately/independently.

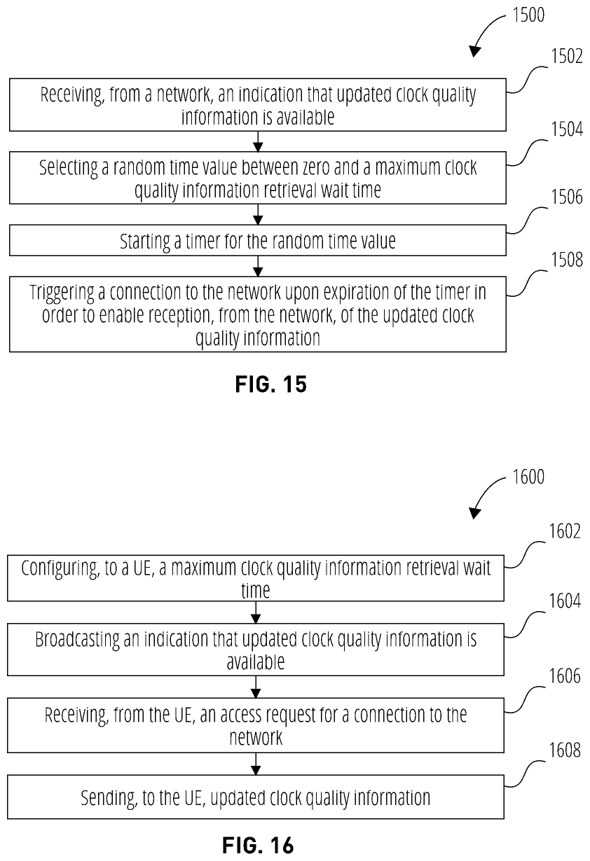

FIG. 15 illustrates a method 1500 of a UE, according to embodiments herein. The method 1500 includes receiving 1502, from a network, an indication that updated clock quality information is available. The method 1500 further includes selecting 1504 a random time value between zero and a maximum clock quality information retrieval wait time. The method 1500 further includes starting 1506 a timer for the random time value. The method 1500 further includes triggering 1508 a connection to the network upon expiration of the timer in order to enable reception, from the network, of the updated clock quality information.

In some embodiments of the method 1500, the maximum clock quality information retrieval wait time comprises an AS maximum clock quality information retrieval wait time. In some such embodiments, the method 1500 further includes receiving the maximum clock quality information retrieval wait time from the network as part of an RRC procedure. In other such embodiments, the method 1500 further includes receiving the maximum clock quality information retrieval wait time from the network in an SI broadcast. In some such embodiments, the maximum clock quality information retrieval wait time is a default/fixed value. In some such embodiments, the maximum clock quality information retrieval wait time is pre-programmed based on an operator preference.

In some embodiments of the method 1500, the maximum clock quality information retrieval wait time comprises a NAS maximum clock quality information retrieval wait time. In some such embodiments, the maximum clock quality information retrieval wait time is configured to the UE by a CN. In some such embodiments, the maximum clock quality information retrieval wait time is configured to the UE during a registration procedure. In some such embodiments, the maximum clock quality information retrieval wait time is a default/fixed value. In some such embodiments, the maximum clock quality information retrieval wait time is pre-programmed based on an operator preference. In some such embodiments, the maximum clock quality information retrieval wait time is configured to the UE during a PDU session establishment procedure. In some such embodiments, the maximum clock quality information retrieval wait time is configured to the UE during a PDU session modification procedure. In some such embodiments, the maximum clock quality information retrieval wait time is configured to the UE during a UE configuration update procedure. In some such embodiments, the maximum clock quality information retrieval wait time is configured to the UE during a port management procedure. In some such embodiments, the maximum clock quality information retrieval wait time is configured to the UE during a UP node management procedure.

FIG. 16 illustrates a method 1600 of a RAN, according to embodiments herein. The method 1600 includes configuring 1602, to a UE, a maximum clock quality information retrieval wait time. The method 1600 further includes broadcasting 1604 an indication that updated clock quality information is available. The method 1600 further includes receiving 1606, from the UE, an access request for a connection to the network. The method 1600 further includes sending 1608, to the UE, updated clock quality information.

In some embodiments of the method 1600, the maximum clock quality information retrieval wait time comprises an AS maximum clock quality information retrieval wait time. In some such embodiments, the maximum clock quality information retrieval wait time is configured by the network as part of an RRC procedure. In other such embodiments, the maximum clock quality information retrieval wait time is configured by the network in an SI broadcast.

In some embodiments of the method 1600, the maximum clock quality information retrieval wait time comprises a NAS maximum clock quality information retrieval wait time. In some such embodiments, the maximum clock quality information retrieval wait time is configured based on CN-provided information. In some such embodiments, the maximum clock quality information retrieval wait time is configured during a registration procedure. In some such embodiments, the maximum clock quality information retrieval wait time is configured during a PDU session establishment procedure. In some such embodiments, the maximum clock quality information retrieval wait time is configured during a PDU session modification procedure. In some such embodiments, the maximum clock quality information retrieval wait time is configured during a UE configuration update procedure. In some such embodiments, the maximum clock quality information retrieval wait time is configured during a port management procedure. In some such embodiments, the maximum clock quality information retrieval wait time is configured during a UP node management procedure.

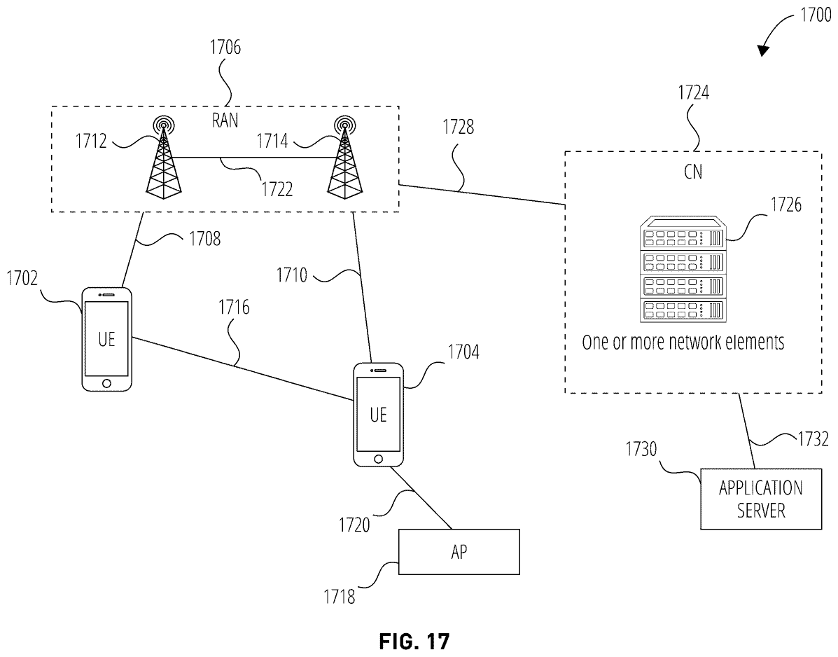

FIG. 17 illustrates an example architecture of a wireless communication system 1700, according to embodiments disclosed herein. The following description is provided for an example wireless communication system 1700 that operates in conjunction with the LTE system standards and/or 5G or NR system standards as provided by 3GPP technical specifications.

As shown by FIG. 17, the wireless communication system 1700 includes UE 1702 and UE 1704 (although any number of UEs may be used). In this example, the UE 1702 and the UE 1704 are illustrated as smartphones (e.g., handheld touchscreen mobile computing devices connectable to one or more cellular networks), but may also comprise any mobile or non-mobile computing device configured for wireless communication.

The UE 1702 and UE 1704 may be configured to communicatively couple with a RAN 1706. In embodiments, the RAN 1706 may be NG-RAN, E-UTRAN, etc. The UE 1702 and UE 1704 utilize connections (or channels) (shown as connection 1708 and connection 1710, respectively) with the RAN 1706, each of which comprises a physical communications interface. The RAN 1706 can include one or more base stations (such as base station 1712 and base station 1714) that enable the connection 1708 and connection 1710.

In this example, the connection 1708 and connection 1710 are air interfaces to enable such communicative coupling, and may be consistent with RAT(s) used by the RAN 1706, such as, for example, an LTE and/or NR.

In some embodiments, the UE 1702 and UE 1704 may also directly exchange communication data via a sidelink interface 1716. The UE 1704 is shown to be configured to access an access point (shown as AP 1718) via connection 1720. By way of example, the connection 1720 can comprise a local wireless connection, such as a connection consistent with any IEEE 802.11 protocol, wherein the AP 1718 may comprise a Wi-Fi® router. In this example, the AP 1718 may be connected to another network (for example, the Internet) without going through a CN 1724.

In embodiments, the UE 1702 and UE 1704 can be configured to communicate using orthogonal frequency division multiplexing (OFDM) communication signals with each other or with the base station 1712 and/or the base station 1714 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1712 or base station 1714 may be implemented as one or more software entities running on server computers as part of a virtual network. In addition, or in other embodiments, the base station 1712 or base station 1714 may be configured to communicate with one another via interface 1722. In embodiments where the wireless communication system 1700 is an LTE system (e.g., when the CN 1724 is an EPC), the interface 1722 may be an X2 interface. The X2 interface may be defined between two or more base stations (e.g., two or more eNBs and the like) that connect to an EPC, and/or between two eNBs connecting to the EPC. In embodiments where the wireless communication system 1700 is an NR system (e.g., when CN 1724 is a 5GC), the interface 1722 may be an Xn interface. The Xn interface is defined between two or more base stations (e.g., two or more gNBs and the like) that connect to 5GC, between a base station 1712 (e.g., a gNB) connecting to 5GC and an eNB, and/or between two eNBs connecting to 5GC (e.g., CN 1724).

The RAN 1706 is shown to be communicatively coupled to the CN 1724. The CN 1724 may comprise one or more network elements 1726, which are configured to offer various data and telecommunications services to customers/subscribers (e.g., users of UE 1702 and UE 1704) who are connected to the CN 1724 via the RAN 1706. The components of the CN 1724 may be implemented in one physical device or separate physical devices including components to read and execute instructions from a machine-readable or computer-readable medium (e.g., a non-transitory machine-readable storage medium).

In embodiments, the CN 1724 may be an EPC, and the RAN 1706 may be connected with the CN 1724 via an S1 interface 1728. In embodiments, the S1 interface 1728 may be split into two parts, an S1 user plane (S1-U) interface, which carries traffic data between the base station 1712 or base station 1714 and a serving gateway (S-GW), and the S1-MME interface, which is a signaling interface between the base station 1712 or base station 1714 and mobility management entities (MMEs).

In embodiments, the CN 1724 may be a 5GC, and the RAN 1706 may be connected with the CN 1724 via an NG interface 1728. In embodiments, the NG interface 1728 may be split into two parts, an NG user plane (NG-U) interface, which carries traffic data between the base station 1712 or base station 1714 and a user plane function (UPF), and the S1 control plane (NG-C) interface, which is a signaling interface between the base station 1712 or base station 1714 and AMFs.

Generally, an application server 1730 may be an element offering applications that use internet protocol (IP) bearer resources with the CN 1724 (e.g., packet switched data services). The application server 1730 can also be configured to support one or more communication services (e.g., VoIP sessions, group communication sessions, etc.) for the UE 1702 and UE 1704 via the CN 1724. The application server 1730 may communicate with the CN 1724 through an IP communications interface 1732.

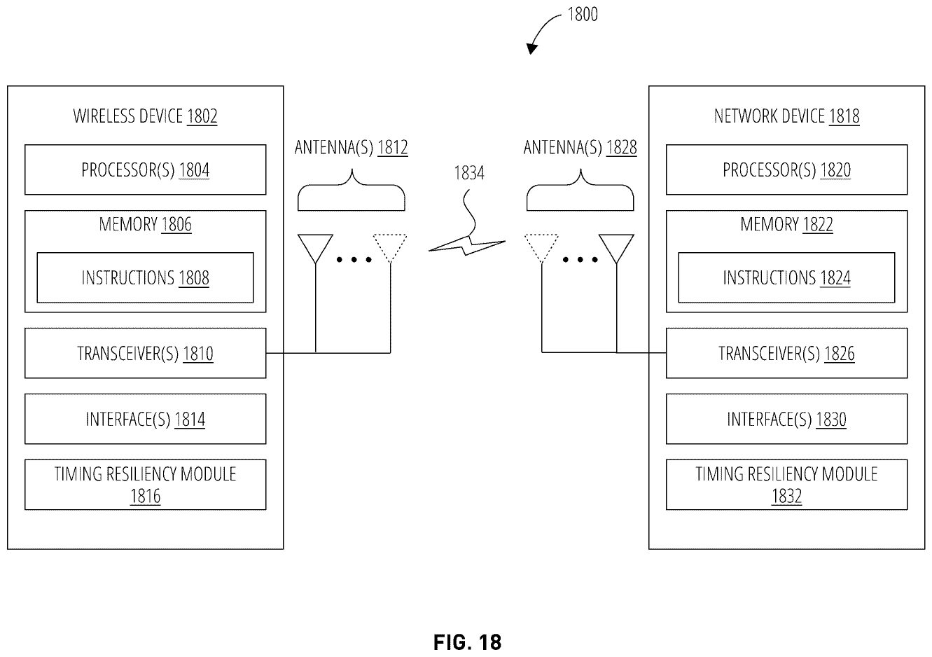

FIG. 18 illustrates a system 1800 for performing signaling 1834 between a wireless device 1802 and a network device 1818, according to embodiments disclosed herein. The system 1800 may be a portion of a wireless communications system as herein described. The wireless device 1802 may be, for example, a UE of a wireless communication system. The network device 1818 may be, for example, a base station (e.g., an eNB or a gNB) of a wireless communication system.

The wireless device 1802 may include one or more processor(s) 1804. The processor(s) 1804 may execute instructions such that various operations of the wireless device 1802 are performed, as described herein. The processor(s) 1804 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1802 may include a memory 1806. The memory 1806 may be a non-transitory computer-readable storage medium that stores instructions 1808 (which may include, for example, the instructions being executed by the processor(s) 1804). The instructions 1808 may also be referred to as program code or a computer program. The memory 1806 may also store data used by, and results computed by, the processor(s) 1804.

The wireless device 1802 may include one or more transceiver(s) 1810 that may include radio frequency (RF) transmitter circuitry and/or receiver circuitry that use the antenna(s) 1812 of the wireless device 1802 to facilitate signaling (e.g., the signaling 1834) to and/or from the wireless device 1802 with other devices (e.g., the network device 1818) according to corresponding RATs.

The wireless device 1802 may include one or more antenna(s) 1812 (e.g., one, two, four, or more). For embodiments with multiple antenna(s) 1812, the wireless device 1802 may leverage the spatial diversity of such multiple antenna(s) 1812 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1802 may be accomplished according to precoding (or digital beamforming) that is applied at the wireless device 1802 that multiplexes the data streams across the antenna(s) 1812 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1802 may implement analog beamforming techniques, whereby phases of the signals sent by the antenna(s) 1812 are relatively adjusted such that the (joint) transmission of the antenna(s) 1812 can be directed (this is sometimes referred to as beam steering).

The wireless device 1802 may include one or more interface(s) 1814. The interface(s) 1814 may be used to provide input to or output from the wireless device 1802. For example, a wireless device 1802 that is a UE may include interface(s) 1814 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1810/antenna(s) 1812 already described) that allow for communication between the UE and other devices and may operate according to known protocols (e.g., Wi-Fi®, Bluetooth®, and the like).

The wireless device 1802 may include a timing resiliency module 1816. The timing resiliency module 1816 may be implemented via hardware, software, or combinations thereof. For example, the timing resiliency module 1816 may be implemented as a processor, circuit, and/or instructions 1808 stored in the memory 1806 and executed by the processor(s) 1804. In some examples, the timing resiliency module 1816 may be integrated within the processor(s) 1804 and/or the transceiver(s) 1810. For example, the timing resiliency module 1816 may be implemented by a combination of software components (e.g., executed by a DSP or a general processor) and hardware components (e.g., logic gates and circuitry) within the processor(s) 1804 or the transceiver(s) 1810.

The timing resiliency module 1816 may be used for various aspects of the present disclosure, for example, aspects of FIG. 1 through FIG. 16. The timing resiliency module 1816 may be configured to operate according to UE-side functionalities of embodiments of AS-timer-based UE access randomization, of embodiments of NAS-timer-based UE access randomization, of embodiments of time synchronization update in RRC_INACTIVE state, of embodiments of random access prioritization, and/or of embodiments of UAC extensions for clock quality information retrieval, as these are described herein.

The network device 1818 may include one or more processor(s) 1820. The processor(s) 1820 may execute instructions such that various operations of the network device 1818 are performed, as described herein. The processor(s) 1820 may include one or more baseband processors implemented using, for example, a CPU, a DSP, an ASIC, a controller, an FPGA device, another hardware device, a firmware device, or any combination thereof configured to perform the operations described herein.

The network device 1818 may include a memory 1822. The memory 1822 may be a non-transitory computer-readable storage medium that stores instructions 1824 (which may include, for example, the instructions being executed by the processor(s) 1820). The instructions 1824 may also be referred to as program code or a computer program. The memory 1822 may also store data used by, and results computed by, the processor(s) 1820.

The network device 1818 may include one or more transceiver(s) 1826 that may include RF transmitter circuitry and/or receiver circuitry that use the antenna(s) 1828 of the network device 1818 to facilitate signaling (e.g., the signaling 1834) to and/or from the network device 1818 with other devices (e.g., the wireless device 1802) according to corresponding RATs.

The network device 1818 may include one or more antenna(s) 1828 (e.g., one, two, four, or more). In embodiments having multiple antenna(s) 1828, the network device 1818 may perform MIMO, digital beamforming, analog beamforming, beam steering, etc., as has been described.

The network device 1818 may include one or more interface(s) 1830. The interface(s) 1830 may be used to provide input to or output from the network device 1818. For example, a network device 1818 that is a base station may include interface(s) 1830 made up of transmitters, receivers, and other circuitry (e.g., other than the transceiver(s) 1826/antenna(s) 1828 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1818 may include a timing resiliency module 1832. The timing resiliency module 1832 may be implemented via hardware, software, or combinations thereof. For example, the timing resiliency module 1832 may be implemented as a processor, circuit, and/or instructions 1824 stored in the memory 1822 and executed by the processor(s) 1820. In some examples, the timing resiliency module 1832 may be integrated within the processor(s) 1820 and/or the transceiver(s) 1826. For example, the timing resiliency module 1832 may be implemented by a combination of software components (e.g., executed by a DSP or a general processor) and hardware components (e.g., logic gates and circuitry) within the processor(s) 1820 or the transceiver(s) 1826.

The timing resiliency module 1832 may be used for various aspects of the present disclosure, for example, aspects of FIG. 1 through FIG. 16. The timing resiliency module 1832 may be configured to operate according to network-side functionalities of embodiments of AS-timer-based UE access randomization, of embodiments of NAS-timer-based UE access randomization, of embodiments of time synchronization update in RRC_INACTIVE state, of embodiments of random access prioritization, and/or of embodiments of UAC extensions for clock quality information retrieval, as these are described herein.

Embodiments contemplated herein include an apparatus comprising means to perform one or more elements of the method 1500. This apparatus may be, for example, an apparatus of a UE (such as a wireless device 1802 that is a UE, as described herein).

Embodiments contemplated herein include one or more non-transitory computer-readable media comprising instructions to cause an electronic device, upon execution of the instructions by one or more processors of the electronic device, to perform one or more elements of the method 1500. This non-transitory computer-readable media may be, for example, a memory of a UE (such as a memory 1806 of a wireless device 1802 that is a UE, as described herein).

Embodiments contemplated herein include an apparatus comprising logic, modules, or circuitry to perform one or more elements of the method 1500. This apparatus may be, for example, an apparatus of a UE (such as a wireless device 1802 that is a UE, as described herein).

Embodiments contemplated herein include an apparatus comprising: one or more processors and one or more computer-readable media comprising instructions that, when executed by the one or more processors, cause the one or more processors to perform one or more elements of the method 1500. This apparatus may be, for example, an apparatus of a UE (such as a wireless device 1802 that is a UE, as described herein).

Embodiments contemplated herein include a signal as described in or related to one or more elements of the method 1500.

Embodiments contemplated herein include a computer program or computer program product comprising instructions, wherein execution of the program by a processor is to cause the processor to carry out one or more elements of the method 1500. The processor may be a processor of a UE (such as a processor(s) 1804 of a wireless device 1802 that is a UE, as described herein). These instructions may be, for example, located in the processor and/or on a memory of the UE (such as a memory 1806 of a wireless device 1802 that is a UE, as described herein).

Embodiments contemplated herein include an apparatus comprising means to perform one or more elements of the method 1600. This apparatus may be, for example, an apparatus of a base station (such as a network device 1818 that is a base station, as described herein).

Embodiments contemplated herein include one or more non-transitory computer-readable media comprising instructions to cause an electronic device, upon execution of the instructions by one or more processors of the electronic device, to perform one or more elements of the method 1600. This non-transitory computer-readable media may be, for example, a memory of a base station (such as a memory 1822 of a network device 1818 that is a base station, as described herein).

Embodiments contemplated herein include an apparatus comprising logic, modules, or circuitry to perform one or more elements of the method 1600. This apparatus may be, for example, an apparatus of a base station (such as a network device 1818 that is a base station, as described herein).

Embodiments contemplated herein include an apparatus comprising: one or more processors and one or more computer-readable media comprising instructions that, when executed by the one or more processors, cause the one or more processors to perform one or more elements of the method 1600. This apparatus may be, for example, an apparatus of a base station (such as a network device 1818 that is a base station, as described herein).

Embodiments contemplated herein include a signal as described in or related to one or more elements of the method 1600.

Embodiments contemplated herein include a computer program or computer program product comprising instructions, wherein execution of the program by a processing element is to cause the processing element to carry out one or more elements of the method 1600. The processor may be a processor of a base station (such as a processor(s) 1820 of a network device 1818 that is a base station, as described herein). These instructions may be, for example, located in the processor and/or on a memory of the base station (such as a memory 1822 of a network device 1818 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
receiving, from a network, an indication that updated clock quality information is available;
selecting a random time value between zero and a maximum clock quality information retrieval wait time;
starting a timer for the random time value; and
triggering a connection to the network upon expiration of the timer in order to enable reception, from the network, of the updated clock quality information.

2. The method of claim 1, wherein the maximum clock quality information retrieval wait time comprises an access stratum (AS) maximum clock quality information retrieval wait time.

3. The method of claim 2, further comprising receiving the maximum clock quality information retrieval wait time from the network as part of a radio resource control (RRC) procedure.

4. The method of claim 2, further comprising receiving the maximum clock quality information retrieval wait time from the network in a system information (SI) broadcast.

5. The method of claim 1, wherein the maximum clock quality information retrieval wait time comprises a non-access stratum (NAS) maximum clock quality information retrieval wait time.

6. The method of claim 5, wherein the maximum clock quality information retrieval wait time is configured to the UE by a core network (CN).

7. The method of claim 5, wherein the maximum clock quality information retrieval wait time is configured to the UE during a registration procedure.

8. (canceled)

9. An apparatus of a user equipment (UE), comprising:
one or more processors; and
a memory storing instructions that, when executed by the one or more processors, configure the UE to:
receive, from a network, an indication that updated clock quality information is available;
select a random time value between zero and a maximum clock quality information retrieval wait time;
start a timer for the random time value; and
trigger a connection to the network upon expiration of the timer in order to enable reception, from the network, of the updated clock quality information.

10. The apparatus of claim 9, wherein the maximum clock quality information retrieval wait time comprises an access stratum (AS) maximum clock quality information retrieval wait time.

11. The apparatus of claim 10, wherein the instructions, when executed by the one or more processors, further cause the UE to receive the maximum clock quality information retrieval wait time from the network as part of a radio resource control (RRC) procedure.

12. The apparatus of claim 10, wherein the instructions, when executed by the one or more processors, further cause the UE to receive the maximum clock quality information retrieval wait time from the network in a system information (SI) broadcast.

13. The apparatus of claim 9, wherein the maximum clock quality information retrieval wait time comprises a non-access stratum (NAS) maximum clock quality information retrieval wait time.

14. The apparatus of claim 13, wherein the maximum clock quality information retrieval wait time is configured to the UE by a core network (CN).

15. The apparatus of claim 13, wherein the maximum clock quality information retrieval wait time is configured to the UE during a registration procedure.

16. A non-transitory computer-readable storage medium including instructions that when executed by one or more processors of a user equipment (UE), cause the UE to:
receive, from a network, an indication that updated clock quality information is available;
select a random time value between zero and a maximum clock quality information retrieval wait time;
start a timer for the random time value; and
trigger a connection to the network upon expiration of the timer in order to enable reception, from the network, of the updated clock quality information.

17. The non-transitory computer-readable storage medium of claim 16, wherein the maximum clock quality information retrieval wait time comprises an access stratum (AS) maximum clock quality information retrieval wait time.

18. The non-transitory computer-readable storage medium of claim 17, wherein the instructions, when executed by the one or more processors, further cause the UE to receive the maximum clock quality information retrieval wait time from the network as part of a radio resource control (RRC) procedure.

19. The non-transitory computer-readable storage medium of claim 17, wherein the instructions, when executed by the one or more processors, further cause the UE to receive the maximum clock quality information retrieval wait time from the network in a system information (SI) broadcast.

20. The non-transitory computer-readable storage medium of claim 16, wherein the maximum clock quality information retrieval wait time comprises a non-access stratum (NAS) maximum clock quality information retrieval wait time.

21. The non-transitory computer-readable storage medium of claim 20, wherein the maximum clock quality information retrieval wait time is configured to the UE by a core network (CN).

22. (canceled)
